(19) United States
(12) Patent Application Publication
(10) Pub. No.: US 2017/0115468 A1
(43) Pub. Date: Apr. 27, 2017

(54) FOLDING OPTICS FOR FOLDING AN OPTICAL PATH IN A LASER PULSE ARRANGEMENT

(71) Applicant: ROFIN-BAASEL LASERTECH GMBH & CO. KG, Starnberg (DE)

(72) Inventors: JAN KASTER, FELDAFING (DE); RAINER BLEICH, GAUTING (DE)

(21) Appl. No.: 15/402,279

(22) Filed: Jan. 10, 2017

Related U.S. Application Data
(63) Continuation of application No. PCT/EP2015/064162, filed on Jun. 23, 2015.

(30) Foreign Application Priority Data
Jul. 10, 2014 (DE) 102014109681.9

(51) Int. Cl. G02B 7/182; G02B 5/122; H01S 3/00

(52) U.S. Cl. CPC G02B 7/182; H01S 3/0057; G02B 5/122

(57) ABSTRACT

Folding optics for a laser pulse compressor contain at least two reflecting elements, each having a flat reflecting surface, which reflecting elements are spatially fixed by a retaining device by a frictional connection in such a way that the two reflecting surfaces are arranged at a definable angle with respect to each other. Accordingly, each of the two reflecting elements is oriented along a respective side surface of an angle block, wherein the two side surfaces are arranged at a definable angle with respect to each other and the angle block serves as an abutment in order to achieve the frictional connection to the retaining device.

### CROSS-REFERENCE TO RELATED APPLICATION

This is a continuation application, under 35 U.S.C. §120, of copending international application No. PCT/EP2015/064162, filed Jun. 23, 2015, which designated the United States; this application also claims the priority, under 35 U.S.C. §119, of German patent application No. DE 10 2014 109 681.9, filed Jul. 10, 2014; the prior applications are herewith incorporated by reference in their entirety.

### BACKGROUND OF THE INVENTION

### Field of the Invention

The invention relates to a folding optics for folding a beam path of a laser pulse arrangement which contains at least two mirror elements that have one planar mirror surface each. The mirror elements are spatially fixed by a retaining apparatus using a force fit such that the mirror surfaces are arranged at a specifiable angle with respect to another. The invention furthermore relates to a laser pulse arrangement containing an arrangement of optical elements, in particular prisms, optical gratings, and/or dispersive mirrors, having at least one such folding optics.

Folding optics of the type mentioned in the introduction are generally known from the prior art and serve in a large number of optical applications for folding a beam path of light or laser beams. Such folding optics are typically particularly sensitive with respect to adjustment errors, and it has therefore proven advantageous to limit the number of degrees of freedom to be justified by way of spatially fixing the optical elements necessary for guiding the beam path, such as for example mirror elements, beam splitters, prisms or the like, with a specifiable orientation with respect to one another by means of a common retaining apparatus.

For example, European patent EP 1 687 876 B1 discloses a folding optics for a laser pulse compressor, in which at least two mirror elements which have one planar mirror surface each are spatially fixed by a retaining apparatus such that the two mirror surfaces are arranged at a specifiable angle with respect to one another.

Step mirrors, for example, for use in optical applications are furthermore available, which comprise two mirror elements that have one planar mirror surface each. The two mirror elements are integrally bonded at the edges by an adhesive bond such that the associated mirror surfaces are arranged perpendicular to one another. With an arrangement of this type, it is possible in a simple manner to effect deflection of an incident laser beam with an anti-parallel offset with respect to the original propagation direction.

However, in particular in the high power range of laser applications it has proven disadvantageous to use compounds containing adhesive for attaching optical elements. The problem here is the emission of gases by adhesive and lubricating substances, in particular of organic compounds such as hydrocarbons, siloxanes or the like at operating temperatures which are typically in the range of room temperature (20 to 35° Celsius) with corresponding cooling. In laser pulse applications with high peak intensities, an interaction with organic compounds can lead to the splitting/ionization thereof. The radicals thus produced are transported within the laser beam to the optics, deposit here and can cause reactions which damage the coatings applied to the optics.

When generating pulsed laser light by mode-locked ultra short pulse laser, the normal or positive dispersion typically caused by the optical elements arranged within the resonator causes pulse widening which must be compensated for by an arrangement of further optical elements, referred to as laser pulse compressor. In some applications, a temporal dispersion is also brought about deliberately in order to amplify the laser pulse (chirped pulse amplification), which is effected with what are known as laser pulse stretchers. For subsequent compression of the laser pulse, arrangements of prisms, optical gratings or dispersive mirrors are known from the prior art, which effectively have an opposite dispersion at least for a spectral range of the generated laser light such that the pulse widening is ideally countered by the provision of pulses of minimum time duration.

It is to be appreciated that the dispersion caused by optical elements is generally dependent on frequency. Accordingly, optical elements can exhibit, for example, negative dispersion in a first frequency range, and can have positive dispersion in a second frequency range. The use of such optics to shorten a pulse duration of a laser pulse in a laser pulse compressor requires that the previously produced dispersion is countered. The same applies to optical arrangements which are used as laser pulse stretchers. However, in this case, the intention is to achieve further drifting apart of the laser pulse, and therefore any existing dispersion is not compensated for, but a corresponding dispersion is added to an existing dispersion. Consequently, the laser pulse stretcher thus has an arrangement of optical elements with a pulse duration lengthening dispersion.

However, it has been shown that the high-intensity laser beam which is guided in laser pulse arrangements of ultra short pulse lasers, such as in particular laser pulse compressors or laser pulse stretchers, typically interacts with substances that are emitted as gases from adhesive bonds or lubricants and which could damage the optical elements used owing to absorption effects.

In principle, reflectors for use as folding optics, which are configured in the form of prisms of different geometries, are also known from the prior art. For example, a prism having a base area in the form of a right-angled isosceles triangle can be used, utilizing total internal reflection, as a low-loss retro reflector in order to effect for example deflection of a beam path by 180°. Such prisms have a geometry which is matched to the respective optical application, with the result that a reduction of the remaining degrees of freedom to be adjusted is effected.

However, it has proven disadvantageous to provide prisms for folding the beam path within laser pulse compressors, since the known optical glasses, in particular BK7 or quartz glass, can exhibit non-linear absorption in an intensity range that is relevant for high-power ultra short pulse lasers, which, owing to the temperature gradient produced by the beam profile, effects a spatially dependent wave front disturbance and in particular a spatially dependent disturbance of the spectral phase. The non-linear disturbance of the spectral phase of the laser pulse correspondingly leads to a limitation of the maximum possible compression by the laser pulse compressor such that the laser pulse generally can no longer be compressed to its minimum time duration.

It is furthermore known, for example from published Japanese patent application JP 2006 337 924 A, to adjust mirror elements with a force fit by means of screw connections. In the field of single-lens reflex cameras, German utility model DE 7 312 689 U discloses an arrangement in which a spring is used to press a mirror element against a device-fixed three-point support. Such a three-point support, however, can produce relatively large stresses that could damage the mirror element during the adjustment.

### SUMMARY OF THE INVENTION

It is an object of the present invention to avoid the disadvantages of the prior art mentioned and to specify a folding optics in particular for a laser pulse arrangement, such as a laser pulse compressor or a laser pulse stretcher, which permits simplified adjustment with largely deformation-free mounting of the mirror elements.

A folding optics for folding a beam path in a laser pulse arrangement contains at least two mirror elements that have a planar mirror surface each, wherein the mirror elements are spatially fixed by a retaining apparatus using a force fit such that the mirror surfaces are arranged at a specifiable angle with respect to another. According to the invention, each of the two mirror elements is aligned along in each case one side face of an angle gauge block, wherein the two side faces are arranged at a specifiable angle with respect to one another. The angle gauge block serves as an abutment for the force-fit connection between the mirror elements and the retaining apparatus.

The invention thus avoids using adhesives to fix the mirror elements, as a result of which possible emission of gases when using the folding optics for folding the beam path of high-intensity laser radiation is also effectively countered. It is thus possible, in particular when using the folding optics for folding a beam path of a laser pulse compressor or a laser pulse stretcher, to ensure minimum impact on the function even when generating high-intensity laser pulses. At the same time, the adjustment complexity necessary for fixing the mirror elements is minimized since the angle to be set at which the two mirror surfaces are to be aligned with respect to one another is specified by the precisely manufactured angle gauge block. For accurate adjustment of this degree of freedom, it thus suffices to press the two planar mirror elements against the corresponding side faces of the angle gauge block functioning as an abutment to produce a force fit. Suitable for force-fit connection are tensioning elements, such as for example set screws or the like, wherein the contact pressure selected is such that the mechanical stability of the mirror elements fixed by the retaining apparatus is ensured, and also such that any occurring mechanical stresses are minimized in order to counter any impact on the optical properties of the thus fixed mirror elements.

The force acting on a respective mirror element to bring about the force connection transmittable directly via a spring element which is configured in the form of a surface and arranged between a tensioning element and the respective mirror element. The spring element is here used for transmitting, in as uniform a manner as possible, the force exerted on the mirror element by the tensioning element to an enlarged support surface in order to minimize any stresses. The spring element furthermore prevents a rotational movement or torsion, which is necessary for fixing purposes in particular in tensioning elements designed as set screws, from being transmitted to the mirror element. This counters possible damage or deformation of the mirror element during the adjustment of the folding optics. The spring element is configured according to one possible exemplary embodiment of the invention similar to a curved leaf spring, the curvature of which faces away from the planar surface of the mirror element. This curvature is configured to compensate for the various thermal expansions of the materials used due to deformation, such that the stress in the mirror substrate is minimized. The spring element is preferably arranged such that the force exerted by the tensioning element on the mirror element acts only in regions in which the angle gauge block forms an abutment on the opposite side in order to avoid stresses in the mirror element by bending or torsion.

The spring element preferably has a curved design and is arranged such that the spring element has at least a convex curvature with respect to a contact surface with the mirror element. Such a configuration serves the purpose of compensating for undesired tension due to material-dependent expansions that may occur if the ambient temperature changes.

In one advantageous embodiment of the invention, a tensioning element, for example the previously mentioned tensioning element, is mounted rotatably about an axis such that the direction of the force which is transferable from the tensioning element is variable. This permits exact alignment of the tensioning element or of the force which is transferred from the tensioning element to the mirror element. In the ideal scenario, the tensioning element is aligned such that the force necessary for fixing the mirror element acts exactly in the direction of the normal vector of the mirror surface so as to ensure mounting which is as free of deformations and stress as possible.

The specifiable angle is preferably less than 120°, in particular 90°. The angle which is specifiable by the angle gauge block is generally matched to the optical application for which the folding optics is intended. Arrangements in which the angle between two mirror surfaces is 90° are used as retro reflectors, in which the propagation direction of the laser beam reflected by the folding optics is directed counter to the original propagation direction of the incident laser beam. In exemplary embodiments in which the specifiable angle is 90°, the angle gauge block which functions as an abutment can have in particular a base area of rectangular or square shape or be in the form of a right-angled triangle.

It is to be understood that angle specifications within the context of the present specification always include a tolerance range that is determined by the manufacturing accuracy. This tolerance range for the angle specifiable by the angle gauge block is typically less than 1°, ideally less than 2.5″, when viewing the entire mirror surface of the mirror element. Accordingly, surfaces are also referred to as planar if they have deviations in the form of irregularities, physical distortions or the like due to manufacturing tolerances. These deviations typically fall within the range of a fraction of the wavelength of the laser used, in particular in the range of an eighth or a tenth of the wavelength, which is typically in the range of 100 nm to 10 μm, in particular up to 3 μm.

In preferred exemplary embodiments of the invention, the angle gauge block consists of metal, ceramic or a glass substrate, which is highly robust with respect to mechanical deformation.

The use of substrates made of glass, metal or ceramic as an angle gauge block additionally has the advantage that the side faces thereof are abradable and/or polishable, which permits particularly precise specification of the angle that is defined by the arrangement of the side faces.

The angle gauge block advantageously consists of a single crystal. A single crystal having a corresponding cubic symmetry, for example pyrite with a primitive cubic lattice, can be grown to serve as a substrate for the angle gauge block. The cleaved single crystals have highly planar contact surfaces, such that the angle that is defined by the thus produced angle gauge block can be specified with particular precision.

In a further development of the invention, a reflective coating is applied on a surface of the angle gauge block. The surface having the reflective coating runs perpendicular to the two mirror surfaces of the mirror elements and thus permits an angle reflector which contains three reflective faces, also referred to as a corner-cube reflector. The reflective coating and the mirror surfaces of the mirror elements are preferably configured such that they have a particularly high reflectivity which is as polarization-independent as possible in the range of the wavelength of the laser beam that is guided by the folding optics.

According to preferred exemplary embodiments of the invention, the retaining apparatus has a base plate and a retaining element that is arranged opposite the base plate. The mirror elements are arranged between the base plate and the retaining element and are connected to the elements in a force-fit manner, wherein the retaining element serves as an abutment in the force-fit fixing. The particular plate-shaped retaining element serves for countering a displacement of the mirror elements from their specified position, even in the case of strongly vibrating strain. In addition, the retaining element can also have for example a milled groove, the dimensions of which correspond to the mirror elements and also counter a dislocation of the mirror element in the direction perpendicular to the applied force. The force necessary to create a force fit is transferable for example by tensioning elements that are known per se, such as in particular set screws, clamps or the like, and acts perpendicular to the plane that is defined by the normal vectors of the mirror surfaces. Such a configuration is distinguished by increased mechanical stability and permits a particularly uniform distribution of the force necessary to obtain force-fit fixing, such that tension or deformations of the mirror elements and of the mirror surfaces thereof can be avoided. However, the retaining element that is located opposite the base plate and serves as an abutment is an optional element, and it is clear that this element may under some circumstances not be necessary for ensuring a sufficiently stable attachment, depending on the application.

A retaining part is with particular preference arranged between the retaining element and a respective mirror element. The retaining part is in mechanical contact with the mirror element and transmits thereto a force serving for the force-fit connection. To this end, the retaining part has a suitable shape, and according to a possible exemplary embodiment, a surface of the retaining element that rests against the mirror element is configured as a hemisphere. In an alternative exemplary embodiment, the surface resting against the mirror element has a planar shape. The retaining element causes extensive decoupling of forces acting in particular in the case of an adjustment of the retaining element, as a result of which a low-deformation attachment of the mirror elements is ensured or damage during installation and any movement of the mirror elements due to vibration can be avoided.

The retaining part and/or the retaining element are preferably spring-mounted to ensure uniform force transmission to the mirror elements and to avoid overloading due to too great a contact pressure force. In one possible exemplary embodiments, the in particular plate-shaped retaining element is attached by attachment rods which are spring-mounted by means of plate-spring assemblies. In another exemplary embodiment, the retaining part is configured in the form of a bolt and spring-mounted in a recess of the retaining element. Coil springs in particular can also be used.

In each case, dampening of the forces acting on the mirror elements is achieved so as to avoid deformations of the mirror elements and also aberrations of the folding optics.

Preferably at least one slot is provided in the base plate of the retaining apparatus, which slot extends parallel to a base area of the base plate and is configured such that, due to the action of force on the base plate in a direction that is perpendicular to the base area of the base plate, inclining of the mirror elements about a first inclination axis may be brought about. A retaining apparatus of such configuration thus permits fine adjustment of degrees of freedom, in particular inclining of the mirror elements, which are attached by the retaining apparatus, by a small angular range without providing hinges herefor. The force necessary for pressing the base plate into contact is transferable for example by way of clamps, set screws or the like, such that the tilting covers the small angular range with a high mechanical stiffness. The use of lubricants is not necessary.

In a further development of the invention, provision is made for a further slot to be provided in the base plate of the retaining apparatus, which slot is parallel to the base area of the base plate and configured such that, by the action of force on the base plate in the direction that is perpendicular to the base area of the base plate, inclining of the mirror elements about a second inclination axis can be brought about. This permits even more exact adjustment of the mirror elements, with the result that the beam path of the laser beam may be specified exactly.

With particular preference, the two slots provided in the base plate extend in different directions such that the first and second inclination axes are parallel with respect one another. Such a configuration permits the fine adjustment of the relevant degrees of freedom for a large number of geometries.

The base plate advantageously has a flexibility that is suitable for inclining the arrangement that is attached thereto.

The base plate is preferably made of metal.

Provision is made in a further development of the invention for a planar top side of the base plate to extend at an angle that is different from zero with respect to a planar bottom side of the base plate that is arranged opposite the top side. Since the mirror elements are disposed on the top side of the base plate, this configuration permits the specification of an angle offset in order to minimize—in dependence on the respective optical application—the adjustment complexity. Moreover, in the case of suitable matching of the angle offsets, the fixing of the base plate—and thus the fine adjustment of the alignment of the mirror elements—can be affected by set screws or the like such that now only angle matching in one direction needs to be effected to completely cover the necessary setting range. This has proven advantageous since such a setting capability can remove the influence of thread play around the zero point position or at least reduces it.

In an embodiment of the base plate with upper and bottom sides that are parallel with respect to one another, any potential thread play of the set screws is generally more strongly noticeable since bidirectional adjustment of the set screws is typically necessary. Such configurations, however, have the advantage that the retaining apparatus in the zero point position is mounted largely without stress, and therefore any misalignment of the mirror elements by way of creep of the screw connection is countered.

In one further development of the invention, provision is made for a further retaining element which is perpendicular to the previously mentioned retaining element and forms a lateral stop or a lateral delimitation for one of the mirror elements. Such an arrangement is configured for effectively countering a displacement of the mirror element even in the case of strong vibrations.

A laser pulse arrangement, containing an arrangement of optical elements, in particular prisms, optical gratings and/or dispersive mirrors, according to the invention contains at least one previously described folding optics. The folding optics is arranged for guiding a laser beam through the arrangement of optical elements.

The arrangement of optical elements is preferably arranged between two folding optics. This permits a particularly compact construction of the laser pulse application, wherein it is possible, if desired, to bring about a height offset when folding the beam path by means of the folding optics.

The retaining apparatus of the folding optics is preferably mounted such that it is displaceable parallel to the propagation direction of the laser beam so as to permit fine adjustment. In particular, it is thus possible to set a length of a laser pulse compressor or laser pulse stretcher.

Referred to as a laser pulse compressor is a laser pulse arrangement with an arrangement of optical elements, in particular prisms, optical gratings and/or dispersive mirrors, which has a dispersion that shortens a pulse duration of the laser pulse.

The arrangement of optical elements of the laser pulse compressor exhibits dispersion for compressing the laser pulse that is counter to a dispersion that exists in at least one spectral range of the modes contained in the laser pulse. The invention provides for the laser pulse compressor to have at least one folding optics according to the invention for folding the beam path. As a result, the impairment of the function of the laser pulse compressor is minimized; in particular it is possible to counter disturbances caused by the emission of gases.

Generally, positive material dispersion occurs in the spectral range around 1 μm in dielectric media, which material dispersion can be compensated for by way of laser compressors having negative dispersion. Such arrangements are known per se, in particular prism compressors or laser pulse compressors are known, which comprise arrangements of dielectric dispersive mirrors or optical gratings.

In addition, waveguide dispersion occurs in optical fibers, which modifies possibly the total dispersion to be compensated for.

In dependence on the frequency of the laser radiation, however, optical elements can cause negative dispersion as well, which is correspondingly compensated for by laser pulse compressors having arrangements of optical elements with effectively positive dispersion.

The retaining apparatus of the folding optics is preferably mounted such that it is displaceable parallel to the propagation direction of the incident laser beam so as to permit setting of the length of the laser pulse compressor.

Provision is made for the mirror elements of the folding optics to be configured in the form of dielectric mirrors. Such mirrors have a large number of layers of varying refractive powers that are located one above another and can be configured such that they have a particularly high reflectivity for a given wavelength. In a further development of the invention, provision is made for dielectric mirrors to be configured such that they have a suitable dispersion for at least one spectral range of the modes contained in the laser pulse such that they can be used for pulse compression. Since the effect of the negative dispersion, which can be achieved by means of dielectric mirrors, is generally small with respect to the effect that may be achieved by arrangements of in particular optical gratings, it is expedient to provide dielectric mirrors merely for fine adjustment of the phase displacements.

In one alternative exemplary embodiment, the laser pulse arrangement is configured in the form of a laser pulse stretcher which accordingly contains an arrangement of optical elements, in particular prisms, optical gratings and/or a dispersive mirrors, which arrangement has a dispersion that lengthens a pulse duration of the laser pulse.

Other features which are considered as characteristic for the invention are set forth in the appended claims.

Although the invention is illustrated and described herein as embodied in a folding optics for folding an optical path in a laser pulse arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a folding optics according to a first exemplary embodiment of the invention, which has two mirror surfaces that are perpendicular to each other;

FIG. 2 is a perspective detail illustration of the folding optics according to the first exemplary embodiment;

FIG. 3 is a sectional view of a detail illustration of a base plate of the folding optics;

FIG. 4 is a side view of an alternative attachment device which has a retaining element that is spring-mounted;

FIG. 5 is a perspective view of the folding optics according to a second exemplary embodiment, which is configured in the form of a corner-cube reflector; and

FIG. 6 is a perspective view of a detail of a base plate of the folding optics according to an alternative exemplary embodiment.

### DETAILED DESCRIPTION OF THE INVENTION

Mutually corresponding parts are provided with the same reference signs throughout the figures.

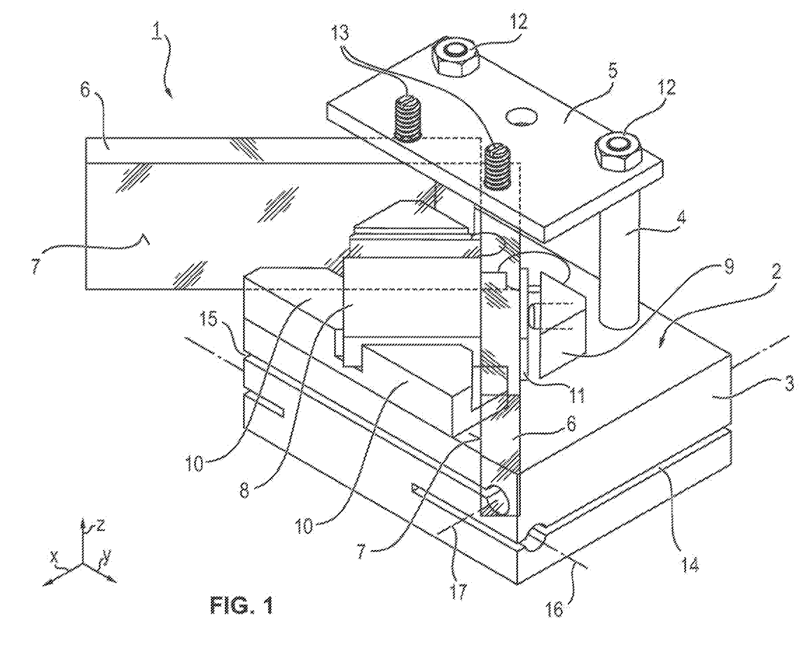

Referring now to the figures of the drawings in detail and first, particularly to FIG. 1 thereof, there is shown a perspective view of a folding optics 1 according to a first exemplary embodiment, which is suitable in particular for use for a laser pulse compressor or a laser pulse stretcher. The folding optics 1 contains a retaining apparatus 2 having a base plate 3, attachment rods 4 and a retaining element 5.

The retaining apparatus 2 serves for attaching in a force-fit manner mirror elements 6, which are arranged between the base plate 3 and the retaining element 5 and whose associated mirror surfaces 7 are arranged at a right angle with respect to one another and are thus configured as an angle reflector.

Provided for a precise specification of the specifiable angle between the two mirror surfaces 7, which in the exemplary embodiment is 90°, an angle gauge block 8 is provided, which consists of a glass substrate having exactly cut and polished side faces against which the mirror surfaces 7 of the mirror elements 6 rest. Accordingly, the angle at which the two mirror surfaces 7 are arranged with respect to one another are specified by the arrangement of the side faces of the angle gauge block 8.

According to alternative exemplary embodiments, the angle gauge block 8 is manufactured from a precisely cut and polished metal substrate or ceramic substrate, in particular steel.

The angle gauge block 8, which in the exemplary embodiment shown in FIG. 1 has a square base area, functions in the case of the force-fit fixing of the mirror elements 6 as an abutment for the force exerted by tensioning elements 9, which in the present case are configured in the form of set screws. A stop 10 of the retaining apparatus 2 delimits, on the side that is located opposite the respective tensioning element 9, a displacement of the angle gauge block 8.

The tensioning elements 9 are mounted rotatably with respect to the base plate 3. The direction of the force exerted by the tensioning element 9 on the mirror element 6 can be set precisely by moving the tensioning elements 9. As a result, any stresses can be minimized so as to avoid imaging errors in the folding optics.

Arranged between the mirror element 6 and the tensioning element 9 is a curved spring element 11, the curvature of which faces away from the mirror element 6 (the curvature cannot be seen in FIG. 1). The spring element 11 ensures that the rotational movement of the set screw 9 that is necessary during the adjustment of the retaining apparatus 2 is not transmitted to the mirror element 6. The spring element 11 also counteracts possible deformations of the mirror element 6. Moreover, the spring action and the surface-type configuration of the spring element 11 permit a particularly uniform distribution of the force that is exerted by the tensioning element 9, such that a nearly stress-free fixing of the mirror elements 6 is ensured. The attachment rods 4 have, at their upper ends, threads that serve for fixing the plate-type retaining element 5 by nuts 12. The retaining element 5 has two recesses into which retaining parts 13 are screwed. The retaining parts 13 are spring-mounted by coil springs (not illustrated further) and are in mechanical contact with the mirror elements 6. The spring-mounted retaining elements 13 bring about minimization of tensions or deformations of the mirror elements 6 in particular when mechanically fixing the retaining elements 5.

In one alternative exemplary embodiment, a groove is provided in the retaining element 5 which serves for receiving a respective mirror element 6. The spatial dimensions are here matched to the mirror element such that displacement of the mirror element 6 in a direction that is perpendicular to the applied force of the force fit can be countered even under strong vibrations.

In an alternative exemplary embodiment (not illustrated further), retaining elements are provided which run perpendicular to the retaining element 5 and form lateral delimitations for the mirror elements 6. The further retaining elements thus form a lateral stop for the mirror elements 6, with the result that the mirror elements 6 do not become dislocated even under strongly vibrating transport and operating conditions.

The base plate 3 of the retaining apparatus 2 has two slots 14, 15 which are arranged in parallel with respect to one another and define two inclination axes 16, 17 which extend perpendicular to one another. The first inclination axis 16, which is formed by the slot 14, extends substantially parallel to a spatial direction Y, whereas the second inclination axis 17, which is formed by the slot 15, extends parallel to the spatial direction X. By means of suitable application of force on the base plate 3 parallel to the spatial direction Z, inclining of the mirror elements 6 that are attached by the retaining apparatuses 2 which is required for fine adjustment may be brought about, wherein the force application necessary herefor can be transferred, for example, by clamps or the like (not illustrated here in more detail). The base plate 3 in the illustrated exemplary embodiment consists of metal and has a flexibility suitable for inclining. The coordinate space referred to here is a three-dimensional Euclidean space (R3) with the standard scalar product.

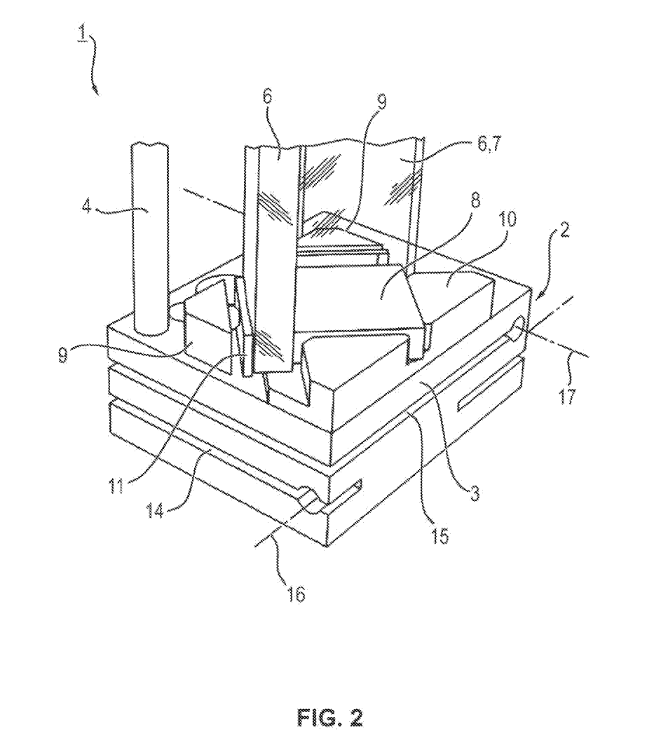

FIG. 2 shows a perspective detail illustration of the lower part of the folding optics 1 according to the first exemplary embodiment. In particular, the tensioning elements 9 which are mounted rotatably on the base plate 3 and are provided for the force-fit attachment of the mirror elements 6 in a lateral direction are shown in particular. The force necessary herefor is capable of being transmitted to the respective mirror elements 6 indirectly via spring elements 11 that are arranged between them, which spring elements 6 in the force-free state are slightly curved, but after the force fit can rest almost flat against the respective mirror element 6. In the case of the force-fit attachment, the angle gauge block 8 serves as an abutment which hereby specifies the relative orientation of the two mirror surfaces 7 with respect to one another.

In an alternative exemplary embodiment, the tensioning elements 9 are fixed.

The base plate 3 has two slots 14, 15, which in each case comprise sections with increased gap width, which define the inclination axes 16, 17.

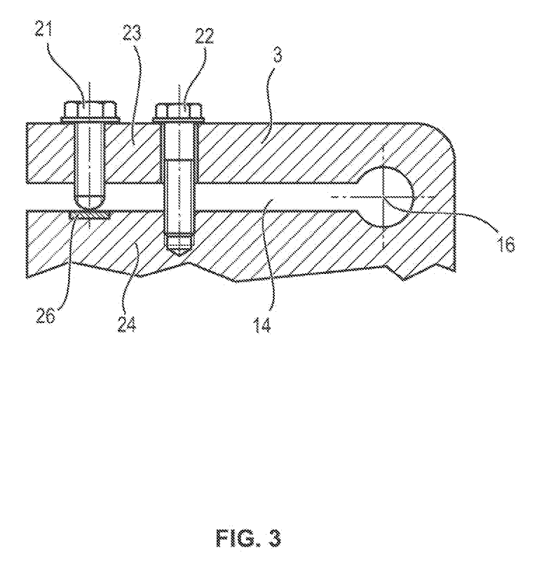

FIG. 3 shows by way of example a section of the base plate 3 having the slot 14 and a mechanism suitable for inclining the base plate 3, which mechanism contains a set screw 21 and a locking screw 22. A force may be transferred to the partial sections 23, 24 of the base plate 3 that are formed by the slot 14 by the set screw 21 in a manner such that the two partial sections 23, 24 can be inclined by a inclination angle with respect one another. After inclining, the set inclination angle is fixable by the locking screw 22, which engages in a corresponding threaded hole in the base plate 3 for fixing the arrangement.

The set screw 21 has, in the illustrated example, a hemispherical pressing end which presses against a disc 26 which consists for example of glass or sapphire and is disposed in the base plate 3.

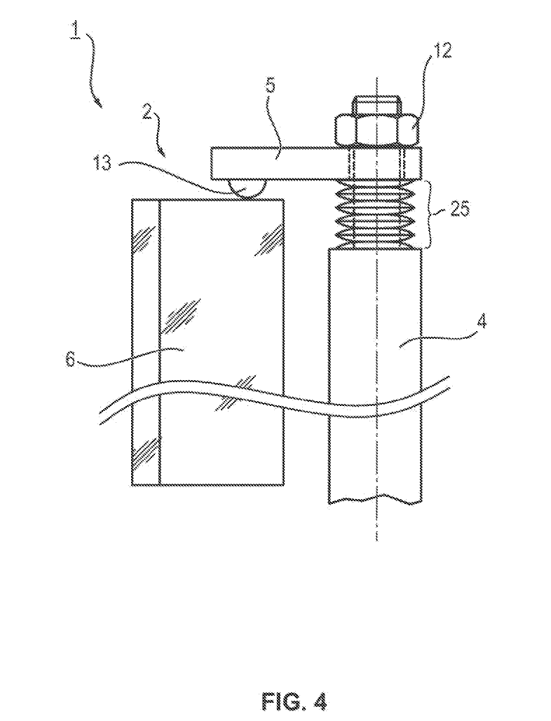

FIG. 4 shows an alternative attachment option for a force-fit fixing of the mirror elements 6 by the retaining apparatus 2. Shown here is the upper portion of the retaining apparatus 2 which contains the retaining element 5, the retaining part 13 and the attachment rod 4. The retaining part 13 has a hemispherical shape in the example illustrated here. In contrast to the embodiment shown in FIG. 1, the retaining part 13 is connected rigidly to the retaining element 5, which, in turn, is spring-mounted to the attachment rods 4 by further spring elements 25, which are configured in the form of plate-spring assemblies or, according to an alternative embodiment, in the form of helical compression springs.

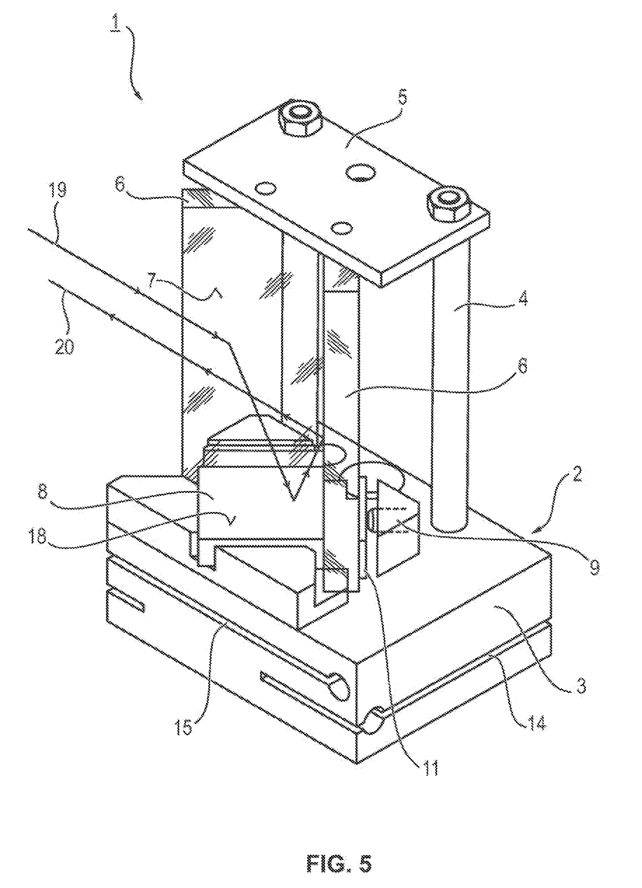

FIG. 5 shows a perspective view of a second exemplary embodiment of the folding optics 1, which is configured in the form of a corner-cube reflector. However, essential components of the exemplary embodiment shown in FIG. 5 are identical to those of the first exemplary embodiment, and for this reason reference is made to the relevant explanation. Specifically, the mechanical attachment of the mirror elements 6 can be correspondingly effected with the attachment means that were already explained with reference to FIGS. 1 to 4. For this reason, only the differences will be dealt with below.

The second exemplary embodiment shown in FIG. 5 differs, besides the configuration of the rectangular mirror elements 6, merely in that the angle gauge block 8, which is used to specify the angle and consists of a glass substrate, has a reflective coating 18. As a result, the coated angle gauge block 8 serves as a mirror in the folding of a beam path. By way of the arrangement of the reflective surfaces 7, 18, which are arranged in each case at a right angle with respect to one another, an angle reflector is produced which is also referred to as a corner-cube reflector and is capable of reflecting an incident laser beam 19 such that the laser beam 20 that is reflected by the folding optics 1 is directed counter to the original propagation direction and travels with a parallel offset thereto.

In an alternative exemplary embodiment of the invention, three mirror elements 6 of equal size are provided, which are arranged according to the corner-cube reflector geometry shown in FIG. 5, wherein the three mirror elements 6 each have a square mirror surface.

Since the use of adhesives or lubricants is avoided, the folding optics 1 illustrated in the exemplary embodiment having mirror elements 6 which are attached with a force fit are particularly suited for use in connection with high-intensity laser pulses, as occur in particular in ultra short pulse laser systems.

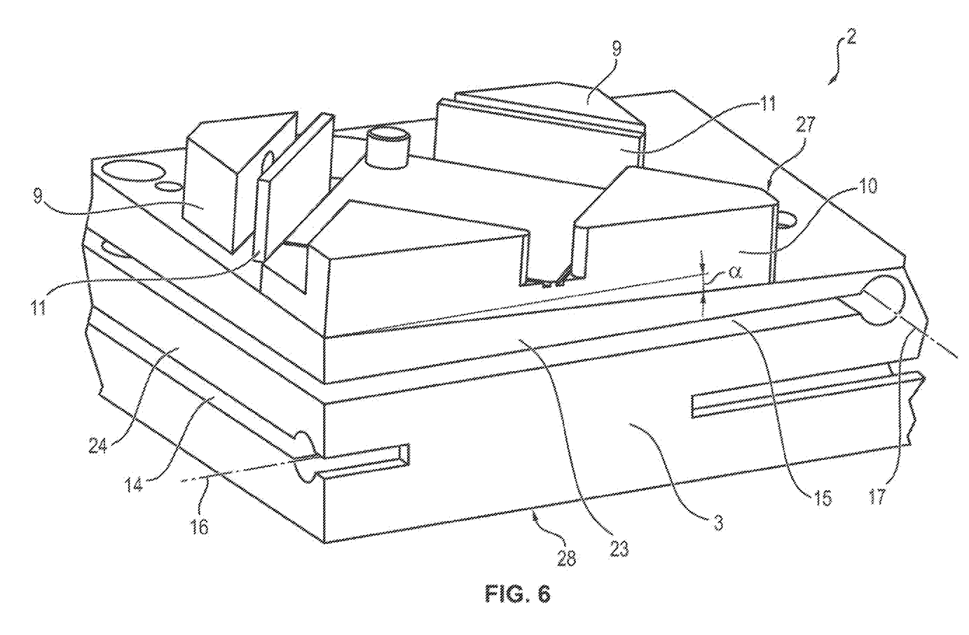

FIG. 6 shows a perspective view of a base plate 3 according to an alternative exemplary embodiment. In contrast to the arrangement shown in FIG. 3, in this case a top side 27 of the base plate 3, which carries the optical setup of mirror elements 6, does not extend parallel to a bottom side 28 of the base plate 3 which is arranged opposite thereto.

In the arrangement shown by way of example in FIG. 6, the bottom side 28 extends parallel to the XY plane, which is defined by the spatial direction X and the spatial direction Y. The top side 27 extends in a plane which extends with a slight tilt with respect to the XY plane, wherein the rotation axis in the example shown extends parallel to the spatial direction Y. The top side 27 extends at an angle α with respect to the bottom side 28 of the bottom plate base plate 3, wherein according to preferred embodiments, the angle α is a few degrees, in particular less than 2°.

The angle α serves for specifying an angle offset for optimally matching the adjustment of the mirror elements 6 to the optical application. In particular, suitable specification of the angle offset permits that the tilting of the partial sections 23, 24 about the inclination axis 16, 17 that is necessary for the adjustment can be effected in a direction such that any thread play of the set screws 21 used for tilting is eliminated. Such thread play usually occurs when adjusting around the zero point position, and consequently in arrangements which have base plates 3 with mutually parallel top and bottom sides 27, 28.

It is to be understood that, as an alternative to the matching of the profile of the top side 27 of the base plate 3 shown in FIG. 6, matching of the bottom side 28 is also possible for specifying the angle offset defined by angle α. What is critical is only that the two surfaces, that is the top side 27 and the bottom side 28, extend at an angle α with respect to one another.

The following is a summary list of reference numerals and the corresponding structure used in the above description:
1 folding optics
2 retaining apparatus
3 base plate
4 attachment rod
5 retaining element
6 mirror elements
7 mirror surface
8 angle gauge block
9 tensioning element
10 stop
11 spring element
12 nut
13 retaining part
14 slot
15 slot
16 inclination axis
17 inclination axis
18 coating
19 incident laser beam
20 reflected laser beam
21 set screw
22 locking screw
23 partial section
24 partial section
25 spring element
26 disc
27 top side
28 bottom side
α angle
X spatial direction
Y spatial direction
Z spatial direction

1. A folding optics for a laser pulse compressor, comprising:
a retaining apparatus;
an angle block gauge having side faces;
a spring element;
a tensioning element; and
at least two mirror elements each having a planar mirror surface and are spatially fixed by said retaining apparatus using a force fit such that said planar mirror surfaces of said mirror elements are disposed at a specifiable angle with respect to another, each of said two mirror elements is aligned along in each case one of said planar side faces of said angle gauge block, wherein each of said two side faces are disposed at a specifiable angle with respect to one another, and said angle gauge block serves as an abutment for a force-fit connection between said mirror elements and said retaining apparatus, wherein a force acting on a respective one of said mirror elements for the force fit is transmittable indirectly via said spring element in a shape of a surface which is disposed between said tensioning element and said respective mirror element.

2. The folding optics according to claim 1, wherein said spring element is of a curved design and disposed such that said spring element has at least a convex curvature with respect to a contact surface with said respective mirror element.

3. The folding optics according to claim 1, further comprising an order tensioning element being mounted rotatably about an axis such that a direction of a force that is transferable from said order tensioning element is variable.

4. The folding optics according to claim 1, wherein the specifiable angle is less than 120°.

5. The folding optics according to claim 1, wherein said angle gauge block is made of a ceramic, a metal or a glass substrate.

6. The folding optics according to claim 5, wherein said angle gauge block consists of a single crystal.

7. The folding optics according to claim 1, wherein said side faces of said angle gauge block are at least one of smoothed or polished.

8. The folding optics according to claim 1, further comprising a reflective coating applied on a surface of said angle gauge block.

9. The folding optics according to claim 1, wherein said retaining apparatus has a base plate and a retaining element that is disposed opposite said base plate and serves as an abutment in a force-fit fixing of said mirror elements that are disposed between said base plate and said retaining element, wherein a force transmitted between said base plate and said retaining element acts perpendicular to a plane defined by normal vectors of said mirror surfaces.

10. The folding optics according to claim 9, further comprising a retaining part disposed between said retaining element and said respective mirror element transfers a force to said respective mirror element for the force fit connection.

11. The folding optics according to claim 10, wherein at least one of said retaining part or said retaining element is spring-mounted.

12. The folding optics according to claim 9, wherein said base plate of said retaining apparatus has at least one slot formed therein, said slot extends parallel to a base area of said base plate and is configured such that, due to an action of force on said base plate in a direction that is perpendicular to the base area of said base plate causes inclining of said mirror elements about a first inclination axis to be brought about.

13. The folding optics according to 12, wherein said base plate of said retaining apparatus has a further slot formed therein, said further slot is parallel to said base area of said base plate and configured such that, by means of the action of force on said base plate in the direction that is perpendicular to said base area of said base plate causes inclining of said mirror elements about a second inclination axis to be brought about.

14. The folding optics according to claim 13, wherein the first and second inclination axes are perpendicular with respect to one another.

15. The folding optics according to claim 12, wherein said base plate has a planar top side that extends at an angle that is different from zero relative to a planar bottom side of said base plate that is disposed opposite said planar top side.

16. The folding optics according to claim 10, wherein said retaining apparatus contains a further retaining element which is disposed perpendicular to said retaining element and forms a lateral delimitation for one of said mirror elements.

17. A laser pulse configuration, comprising:
a configuration of optical elements selected from the group consisting of prisms, optical gratings and dispersive mirrors; and
at least one folding optics disposed for guiding a laser beam through said configuration of optical elements, said at least one folding optics containing:
a retaining apparatus;
an angle block gauge having side faces;
a spring element;
a tensioning element; and
at least two mirror elements each having a planar mirror surface and are spatially fixed by said retaining apparatus using a force fit such that said mirror surfaces of said mirror elements are disposed at a specifiable angle with respect to another, each of said two mirror elements is aligned along in each case one of said side faces of said angle gauge block, wherein each of said two side faces are disposed at a specifiable angle with respect to one another, and said angle gauge block serves as an abutment for a force-fit connection between said mirror elements and said retaining apparatus, wherein a force acting on a respective one of said mirror elements for the force fit is transmittable indirectly via said spring element in a shape of a surface which is disposed between said tensioning element and said respective mirror element.

18. The laser pulse configuration according to claim 17, wherein said at least one folding optics is one of two folding optics and said configuration of optical elements is disposed between said two folding optics.

19. The laser pulse configuration according to claim 17, wherein said retaining apparatus of said folding optics is mounted such that it is displaceable parallel to a propagation direction of the laser beam.

20. The laser pulse configuration according to claim 17, wherein said configuration of optical elements has a dispersion which shortens a pulse duration of a laser pulse.

21. The laser pulse configuration according to claim 17, wherein said configuration of optical elements has a dispersion which lengthens a pulse duration of a laser pulse.
